(19) United States
(12) Patent Application Publication
(10) Pub. No.: US 2020/0187535 A1
(43) Pub. Date: Jun. 18, 2020

(54) CALORIE REDUCED SUGAR SUBSTITUTE COMPOSITIONS

(71) Applicant: FTC INTERNATIONAL CONSULTING LTD., Pitt Meadows (CA)

(72) Inventors: Evdokia Savova, Coquitlam (CA); Walter G. Dullemond, Pitt Meadows (CA)

(21) Appl. No.: 16/613,112

(22) PCT Filed: May 14, 2018
(86) PCT No.: PCT/CA2018/050573

§ 371 Date: Nov. 12, 2019

Related U.S. Application Data
(60) Provisional application No. 62/505,804, filed on May 12, 2017.

(51) Int. Cl. A23L 27/30; A23L 33/21; A23L 27/00

(52) U.S. Cl. CPC A23L 27/36; A23V 2002/00; A23L 27/84; A23L 33/21

(57) ABSTRACT

A sugar substitute composition comprises a digestion resistant soluble fiber and a stevia leaf extract. The sugar substitute composition may include a natural masking flavor. The digestion resistant soluble fiber may be an isomalto-oligosaccharide.

### BACKGROUND OF THE INVENTION

### Field of the Invention

The present invention relates to sugar substitute compositions and, in particular, to a sugar substitute composition which may be used in place of natural sugars and/or artificial sweeteners in both consumer and industrial applications.

### Description of the Related Art

United States Patent Application Publication No. 2016/0165941 which was published on Jun. 16, 2016, in the name of Hofmekler and the full disclosure of which is incorporated herein by reference, discloses sugar substitute compositions comprising natural ingredients that provide added human health benefits and properties and characteristics of sugar, without the caloric content and glycemic index of sugar. Unlike artificial sweeteners, the sugar substitute compositions contain no chemicals or synthetic additives and taste and function like sugar. Specifically, the sugar substitute compositions comprise digestion resistant soluble fiber comprising an oligosaccharide matrix of glucose and/or fructose oligomers, which yield the sugar substitute digestion resistant property and allow it to simultaneously enhance the growth of beneficial bacteria in the human gut. In one particular embodiment, the sugar substitute comprises a digestion resistant soluble fiber, Luo Han Guo extract, and a flavor masking agent comprising Oryza sativa (rice) extract. In another embodiment, the sugar substitute comprises a digestion resistant soluble fiber, Luo Han Guo extract, a flavor masking agent comprising Oryza sativa (rice) extract, and a steviol glycoside.

### SUMMARY OF THE INVENTION

It is an object of the present invention to provide a sugar substitute composition comprised of natural ingredients which have reduced calories and glycemic index.

There is accordingly provided a sugar substitute composition comprising a digestion resistant soluble fiber and a stevia leaf extract. The sugar substitute composition may include a natural masking flavor. The digestion resistant soluble fiber may be at least one digestion resistant soluble fiber selected from the group of digestion resistant soluble fibers including fructo-oligosaccharide, galacto-oligosaccharide, malto-oligosaccharide, isomalto-oligosaccharide, mannan-oligosaccharide, and a mixture of glycoprotein and polysaccharides derived from the Acacia senegal and/or Vachiella (Acacia) seyal tree. The stevia leaf extract may be at least one stevia leaf extract selected from the group of stevia leaf extracts including Rebaudioside A, Rebaudioside B, Rebaudioside C, Rebaudioside D, Rebaudioside E, Rebaudioside M, Ducoside A, Stevioside, and other extracts from the plant Stevia Rebaudiana. The sugar substitute composition may further include a fructo-oligosaccharide. The fructo-oligosaccharide may be inulin.

An example of the sugar substitute composition may comprise between 99.00% and 99.99% by weight of an isomalto-oligosaccharide and between 0.01% and 1.00% by weight of stevia leaf extract.

An example of the sugar substitute composition may comprise between 99.00% and 99.99% by weight of an isomalto-oligosaccharide, between 0.01% and 0.75% by weight of stevia leaf extract, and between 0.00% and 0.25% by weight of natural masking flavor.

An example of the sugar substitute composition may comprise between 15.00% and 85.00% by weight of an isomalto-oligosaccharide, between 14.89% and 84.25% by weight of water, and between 0.01% and 0.75% by weight of stevia leaf extract.

### DESCRIPTIONS OF THE SPECIFIC EMBODIMENTS

Disclosed herein are sugar substitute compositions comprised of digestion resistant soluble fiber and a stevia leaf extract. The digestion resistant soluble fiber is an isomalto-oligosaccharide in this example. The sugar substitute composition may be used in place of natural sugars and/or artificial sweeteners in both consumer and industrial applications. An example of such a sugar substitute composition is set out below. The sugar substitute composition comprises only the digestion resistant soluble fiber and the stevia leaf extract.

### Example 1

| Component | Percent by Weight |
|---|---|
| Isomalto-oligosaccharides (IMO) | 99.00% to 99.99% |
| Stevia leaf extract | 0.01% to 1.00% |
| Total | 100.00% |

The sugar substitute composition may further include 0.00% to 0.25% by weight of a natural masking flavor. An example of such a sugar substitute composition further including a natural masking flavor is set out below. The sugar substitute composition comprises only the digestion resistant soluble fiber, the stevia leaf extract, and the natural masking flavour.

### Example 2

| Component | Percent by Weight |
|---|---|
| Isomalto-oligosaccharides (IMO) | 99.00% to 99.99% |
| Stevia leaf extract | 0.01% to 0.75% |
| Natural masking flavor | 0.00% to 0.25% |
| Total | 100.00% |

The sugar substitute composition may also be provided in a liquid or syrup form comprised of a digestion resistant soluble fiber which, in this example, is an isomalto-oligosaccharide, water, a stevia leaf extract, and natural masking flavor. An example of a sugar substitute composition in a liquid or syrup form is set out below. The sugar substitute composition comprises only the digestion resistant soluble fiber, water, and the stevia leaf extract.

### Example 3

| Component | Percent by Weight |
|---|---|
| Isomalto-oligosaccharides (IMO) | 15.00% to 85.00% |
| Water | 14.99% to 84.25% |
| Stevia leaf extract | 0.01% to 0.75% |
| Total | 100.00% |

The sugar substitute composition may further include a fructo-oligosaccharide substituted for isomalto-oligosaccharides. The fructo-oligosaccharide may increase the viscosity of the sugar substitute composition and thereby batter viscosity when the sugar substitute composition is used in a batter. The fructo-oligosaccharide may be between 5.000% and 69.000% by weight of the sugar substitute composition. An example of a sugar substitute composition further including a fructo-oligosaccharide, in which the fructo-oligosaccharide is inulin, is set out below.

### Example 4

| Component | Percent by Weight |
|---|---|
| Isomalto-oligosaccharides (IMO) | 30.00% to 94.99% |
| Fructo-oligosaccharides (Inulin) | 5.00% to 69.00% |
| Stevia leaf extract | 0.01% to 0.75% |
| Natural masking flavor | 0.00% to 0.25% |
| Total | 100.00% |

The sugar substitute compositions disclosed herein may alternatively comprise at least one digestion resistant soluble fiber selected from the group of digestion resistant soluble fibers including fructo-oligosaccharide, galacto-oligosaccharide, malto-oligosaccharide, isomalto-oligosaccharide, mannan-oligosaccharide, and a mixture of glycoprotein and polysaccharides derived from the Acacia senegal and/or Vachiella (Acacia) seyal tree.

The sugar substitute compositions disclosed herein may impart sweetening, bulking, texture, humectancy, and browning (during heat treatment). Sweetening is imparted in all applications. Bulking may be imparted to baked goods, confections and ice cream. Humectancy may be imparted to assist with texture, mouthfeel, and increasing shelf life in controlling moisture. Maillard browning may be imparted to baked goods similar to sugar. The sugar substitute composition may have reduced calories compared to sugar and may contribute dietary fiber to food and promote beneficial gut bacteria.

The sugar substitute composition disclosed herein may be used in a variety of food products including, but not limited to, baked goods, confections, and sauces as set out in the examples below.

### White Cake

| Component | Percent by Weight |
|---|---|
| Sugar substitute composition | 25% to 28% |
| Milk | 22% to 25% |
| White Flour | 18% to 20% |
| Eggs | 16.50 to 21.65% |
| Oil | 8% to 10% |
| Baking Soda | 1.25% to 1.75% |
| Vanilla Extract | 1.0% to 1.5% |
| Salt | 0.1% to 0.25% |
| Total | 100.00% |

The white cake comprises between 24.75% and 27.972% by weight oligosaccharides, between 0.025% and 0.210% by weight stevia leaf extract and between 0.00% and 0.070% by weight natural flavour as components of the sugar substitute composition.

### Milk Chocolate

| Component | Percent by Weight |
|---|---|
| Roasted cocoa beans | 24.6% to 30.85% |
| Cocoa butter | 17% to 19% |
| Whole milk powder | 17% to 19% |
| Sunflower lecithin | 0.1 to 0.2% |
| Vanilla Extract | 0.05% to 0.2% |
| Sugar substitute composition | 35% to 37% |
| Total | 100.00% |

The milk chocolate comprises between 34.65% and 36.963% by weight oligosaccharides, between 0.035% and 0.2775% by weight stevia leaf extract and between 0.00% and 0.0925% by weight natural flavour as components of the sugar substitute composition.

### Barbecue Sauce

| Component | Percent by Weight |
|---|---|
| Water | 28% to 32% |
| Tomato paste | 29.5% to 31% |
| Sugar substitute composition | 12% to 13% |
| Vinegar | 22% to 22.9% |
| Tapioca dextrin | 1.25% to 1.5% |
| Corn starch | 0.25% to 0.55% |
| Spices | 0.75% to 1.25% |
| Liquid smoke | 0.05% to 0.15% |
| Lemon juice | 0.05% to 0.15% |
| Salt | 1.5% to 2.15% |
| Total | 100.00% |

The barbecue sauce comprises between 11.88% and 21.987% by weight oligosaccharides, between 0.013% and 0.0975% by weight stevia leaf extract and between 0.00% and 0.0325% by weight natural flavour as components of the sugar substitute composition.

It will be understood by a person skilled in the art that many of the details provided above are by way of example only, and are not intended to limit the scope of the invention which is to be determined with reference to the following claims.

1. A sugar substitute composition comprising:
between 99.00% and 99.99% by weight of a digestion resistant soluble fiber; and
between 0.01% and 1.00% by weight of a stevia leaf extract.

2. The sugar substitute composition as claimed in claim in 1 comprising only the digestion resistant soluble fiber and the stevia leaf extract.

3. The sugar substitute composition as claimed in claim 1 further including up to 0.25% by weight of a natural masking flavor.

4. The sugar substitute composition as claimed in claim 1 wherein the digestion resistant soluble fiber is at least one digestion resistant soluble fiber selected from the group of digestion resistant soluble fibers including fructo-oligosaccharide, galacto-oligosaccharide, malto-oligosaccharide, isomalto-oligosaccharide, mannan-oligosaccharide, and a mixture of glycoprotein and polysaccharides derived from an Acacia senegal and/or Vachiella (Acacia) seyal tree.

5. The sugar substitute composition as claimed in claim 1 where the stevia leaf extract is at least one stevia leaf extract selected from the group of stevia leaf extracts including Rebaudioside A, Rebaudioside B, Rebaudioside C, Rebaudioside D, Rebaudioside E, Rebaudioside M, Ducoside A, Stevioside, and other extracts from the plant Stevia Rebaudiana.

6. A sugar substitute composition comprising:
between 15.00% and 85.00% by weight of a digestion resistant soluble fiber;
between 14.99% and 84.25% by weight of water; and
between 0.01% and 1.00% by weight of a stevia leaf extract.

7. The sugar substitute composition as claimed in claim 6 comprising only the digestion resistant soluble fiber, water, and the stevia leaf extract.

8. The sugar substitute composition as claimed in claim 6 further including up to 0.25% by weight of a natural masking flavor.

9. The sugar substitute composition as claimed in claim 6 wherein the digestion resistant soluble fiber is at least one digestion resistant soluble fiber selected from the group of digestion resistant soluble fibers including fructo-oligosaccharide, galacto-oligosaccharide, malto-oligosaccharide, isomalto-oligosaccharide, mannan-oligosaccharide, and a mixture of glycoprotein and polysaccharides derived from an Acacia senegal and/or Vachiella (Acacia) seyal tree.

10. The sugar substitute composition as claimed in claim 6 wherein the stevia leaf extract is at least one stevia leaf extract selected from the group of stevia leaf extracts including Rebaudioside A, Rebaudioside B, Rebaudioside C, Rebaudioside D, Rebaudioside E, Rebaudioside M, Ducoside A, Stevioside, and other extracts from the plant Stevia Rebaudiana.

11. A food product comprising a sugar substitute composition as claimed in claim 1.

12. A food product comprising a sugar substitute composition as claimed in claim 6.
